(19) United States
(12) Patent Application Publication
(10) Pub. No.: US 2006/0033597 A1
(43) Pub. Date: Feb. 16, 2006

(54) Wireless safety alarm with enlarged actuator button

(76) Inventors: James D. Wells, Linden, MI (US); Michael Marks, Orleans, MA (US)

Correspondence Address: Brad I Golstein;WorkTools, Inc., 20755 Plummer Street, Chatsworth, CA, 91311, US

(21) Appl. No.: 11/201,185

(22) Filed: Aug. 11, 2005

Related U.S. Application Data
(60) Provisional application No. 60/600,540, filed on Aug. 11, 2004.

(51) Int. Cl. H01P 1/203

(52) U.S. Cl. 333/204

(57) ABSTRACT

A wireless alarm system incorporates a battery powered transmitter and a battery powered receiver. The transmitter features an enlarged actuation button with a high point that, together with the hinge, describes a torque arm. The receiver unit incorporates an alarm and a receptacle for storing the transmitter unit. When a user pushes the button a signal is sent to the transmitter causing it to sound an audible alarm.

### FIELD OF THE INVENTION

The present invention relates to push button wireless actuators dedicated to single purpose receivers. More precisely, the present invention relates to a stand-alone panic button alarm system.

### BACKGROUND OF THE INVENTION

The prior art discloses a wide range of security alarm systems. Alarm systems have been around for many years and continue to grow in complexity and cost.

An alarm system commonly found in a home today consists of various types of detection equipment. The detection equipment may consist of magnetic switches, infrared sensors, pressure switches, ultrasonic sensors, light beams, glass break detectors and even a panic switch. A panic switch is typically a small, doorbell style switch mounted next to an entrance door or near the master bed. All of these detectors are generally hard wired in series or parallel loops with the central alarm controller waiting for a detector to sense the presence of an intruder, attempted intrusion or a signal from a panic switch wired within the household. Once a detector changes its normal state a series of events occur. The alarm controller may sound an audible/visual alarm. The alarm controller may place a phone call, and/or play a pre-recorded message. The alarm controller could start a video recording system. These are just a few of the many capabilities of a modern alarm system. The combination of so many functions adds complexity and raises the cost of the conventional alarm system. The present invention incorporates technology that is similar to that found in wireless doorbells and garage door openers.

U.S. Pat No. D288,930 by Barbara et al. discloses a two button computer mouse.

U.S. Pat No. D478,606 by Guzman et al. discloses an ornamental design of a garage door opener actuation unit with an enlarged button.

U.S. Pat. No. 5,396,222 by Markus et al. discloses an ergonomic actuation device that sends a control signal to a machine.

U.S. Pat No. 5,450,064 by Williams et al. discloses a medical alert device that incorporates a single enlarged round button. A descending beveled edge in the top surface of the actuator housing surrounds the button such that the bottom edge of the button is below the surface of the housing top.

U.S. Pat. No. 5,803,238 by Roza discloses a door opener switch with a cylindrical housing and a button axially movable in the housing for actuating a switch member.

U.S. Pat. No. 5,923,255 by Vahdatshoar discloses a child danger signaling device that utilizes a wireless signal.

U.S. Pat. No. 6,414,589 by Angott and Xydis discloses a wireless means for activating a doorbell chime.

Conventional alarm systems are expensive to install, are expensive to maintain, and may cost money for monthly monitoring fees. In order to make common alarms systems available to the general public an alarm company may offer a reduced installation fee in exchange for a long term contract requiring monthly payments. The offer of such contracts often requires a credit history. The alarm company does not want to absorb a costly installation if the homeowner will not be able to pay the inflated monthly fees for the term of the contract.

Many alarm service contracts also charge extra fees if the user activates the alarm more than a few times during a specified time period. This creates a disincentive to sound the alarm in cases where the user is uncertain whether or not the threat is real. Users will feel more secure and less stressed if they could sound the alarm freely without concern of bothering service providers and/or incurring additional charges even incases where the “threat” may seem frivolous.

Conventional alarm systems are permanently installed and expensive to update as technologies change. A person renting a home, apartment, condo, hotel room or dorm room may be prohibited in their contract from installing a conventional wired alarm system.

With the continual rising costs of installation, operation, maintenance, monitoring and updates, fewer people are able to afford the protection of conventional alarm systems. As the trend for long term contracts for alarm services continues fewer people can afford or even qualify for such devices.

As societal values have changed, divorced/single parent families have increased in the percentage of the total population. Children are often left alone at home after school hours. These children may not possess the skills to operate a conventional alarm system. Single parent households have fewer adults in them to provide mutual support in case of trouble in the form of violence or crime. Single parent households on average have a lower average income as a two-parent household.

As life expectancy has grown, the percentage of population living on a fixed income has increased dramatically. With “baby boomers” now hitting retirement age (and therefore fixed incomes) this percentage will climb even higher. As people age and become elderly, their motor skills and manual dexterity are also diminished.

Handicapped individuals typically have reduced incomes and reduced motor skills and dexterity.

Thus there is a need for a low cost alarm unit affordable by people with low income and/or poor credit, a device easily operated by children, the elderly, and handicapped. The alarm system should also be easily installed and easily moved and reinstalled.

Push button actuators that switch a device on and off and/or send a signal to actuate another device exist in many different shapes and constructions. Small, round, rectangular, inset, overlapping and protruding push button interfaces are all known in the art. However, the function of the prior art buttons does not anticipate a design optimized for a low cost, portable, wireless, panic button.

The present invention does not normally trigger an alarm when a door or window is opened, nor does it normally protect the property of people. However it is possible that the present invention could be installed in a manner to provide these functions. The present invention is primarily designed to help people protect themselves. The present invention is designed to be a low cost alternative to a wired alarm system. The present system requires manual input by the homeowner when he or she feels threatened by an intruder or others within the proximity of their location. It is designed to simultaneously scare any intruder and alert neighbors of the threat. It is designed to provide affordable protection and feeling of security to people in their home, apartment, condo, hotel room, dorm room, camper etc.

The present alarm system could easily be carried to locations other than the home. It could be used in a hotel room, dorm room, camper, tent or any other location a person may travel to.

Multiple transmitter units can be used to provide multiple location access and activation of one or many receivers units.

Multiple receiver units can be used to provide both indoor, outdoor and multiple location audible alarm notification from one or many transmitter units when the receiver units are located within the individual transmitters transmission range.

Neighbors within the transmitter's range could activate each other's alarms (if on the same digital code) to provide a small neighborhood security/protection network.

Typical button/transmitter mounting locations:
Near household entry points, such as beside the front door—this enables quick activation if the user is accosted while entering the home or if an intruder tried to push an entry door open.
Bedroom night stand—easy activation by the bedside.
Closet or other hiding location when an intruder is believed to be in the household.

Typical Receiver Mounting Locations:
Under the overhanging eve of the house, alert neighbors.
Inside the household near likely points of intruder entry to scare any intruder and alert others within the household.

Expansion Products

The present invention may incorporate the following to expand its capabilities:
Wireless Intrusion Devices to interface with this product
Wireless Panic Interface to existing “Wired Alarm System”
Phone Dialer/PreRecorded message to 911
Necklace Pendant Transmitter

Lighted receiving unit to provide both audible and flashing light to alert neighbors, police or light up the home.

Light Bulb Extension Socket would screw into an existing light fixture, contain a receiver and turn on a light bulb when alarm signal is detected. According to this embodiment the light fixture may provide operating power to the unit.

It is the goal of the present invention to provide a low cost security system which can be used in any physical building, structure, household, home, apartment, hotel room, dorm room, houseboat etc.

It is another object of the present invention to provide a system which can be easily installed and removed by the homeowner.

It is still another object of the present invention to provide an alarm system with an extremely low installation cost, that is easy to maintain, requires little or no expenditure of energy, and is well within the financial reach of even relatively poor homeowners.

It is still another object of the present invention to provide a very loud audible alarm which can be easily mounted on the interior or exterior wall of a living space so that when an alarm is activated, neighbors and any intruders or threatening persons will be alerted to the alarm.

It is yet another object of the present invention to provide a relatively low cost alarm system which can be located on any surface of the building wherein a transmitter/switch unit can be used in any location inside or outside, either fixed or portable, within the receiver's range of the transmitted signal.

It is still and other object of the invention to provide a transmitter/actuating device that is easy to actuate wherein an enlarged push-button switch interface substantially covers the underlying housing and a frame protects the edges of the actuation button against interferences from walls and table top objects.

It is still another object of the present invention to provide a remote control transmitter unit and receiver means for controlling the operation of the Alarm and Quiet states of the alarm.

It is yet a further object of the present invention to provide a simple, easy-to-maintain, easy-to-install, audio alarm package which is battery powered with a retail price of less than $30.

### SUMMARY OF THE INVENTION

The present invention comprises a home security alarm system incorporating a button/transmitter unit and a siren/receiver unit each powered by its own low voltage DC power source. The transmitter communicates through digitally encoded radio frequency (RF) signals to activate/de-activate the siren/receiver unit.

When the button on the transmitter unit is depressed a first time a signal is sent to the receiver unit causing the siren to sound. When the button is depressed a second time a signal is sent to the receiver unit causing the siren to be silenced. The button, linked by means of RF signal acts as a simple on/off switch.

The housing of the button/transmitter unit has two primary components: 1) a square housing with a bottom, four walls and a square cavity and 2) a square button that covers the cavity. Inside the cavity are housed the transmitter, battery and a mechanical switch that causes the transmitter to send a signal when the button cover is depressed. The bottom of the housing may incorporate one or all of the following elements: a keyhole for hanging the unit on a wall; rubber feet for protecting a table top; a rubbery material covering the entire base that to prevent the unit from sliding off a table top; a recess for utilizing a hook and loop fastener method.

The housing of the receiver/siren unit is comprised of a bottom, walls and a top. The top of the housing may incorporate a square recess into which the button/transmitter unit may be nested. The top of the housing also has holes to facilitate the transmission of sound from the siren. Inside the housing are the receiver, siren and batteries. The bottom of the housing may incorporate a recess for hanging the unit on a wall and/or a recess for utilizing a hook and loop fastener method.

### BRIEF DESCRIPTION OF THE DRAWINGS

FIG. 1A shows button/transmitter assembly 10. Button 30 substantially covers the top surface of the assembly and is surrounded by frame 20. Hinge 43 is located along one edge, away from center of button 35. High point 50 is located near center of button 35. Torque arm 62 is shown connecting hinge 43 with high point 50.

FIG. 1B shows button 30 in a depressed position causing it to send a signal to siren 80.

FIG. 1C shows the relative positions of hinge 43, high point 50 and press zone 135 on Button 30.

FIG. 2A shows siren 80 with recess area 85 for button/transmitter 10. Speaker cover 82 is also shown.

FIG. 2B shows solar panel 120 incorporated onto the siren and the button/transmitter. Note that on the button transmitter press zone 135 is distinct from solar panel 120.

FIG. 3 shows receiver/siren 80 incorporating cellular interface 103 and cellular telephone 88.

FIG. 4 shows receiver/siren 80 incorporating video camera 202, receiver computer 94 and wireless interface 101. Wireless interface 101 is connected to location computer 90, internet 200 and remote computer 96.

### DETAILED DISCLOSURE OF THE PREFERRED EMBODIMENTS

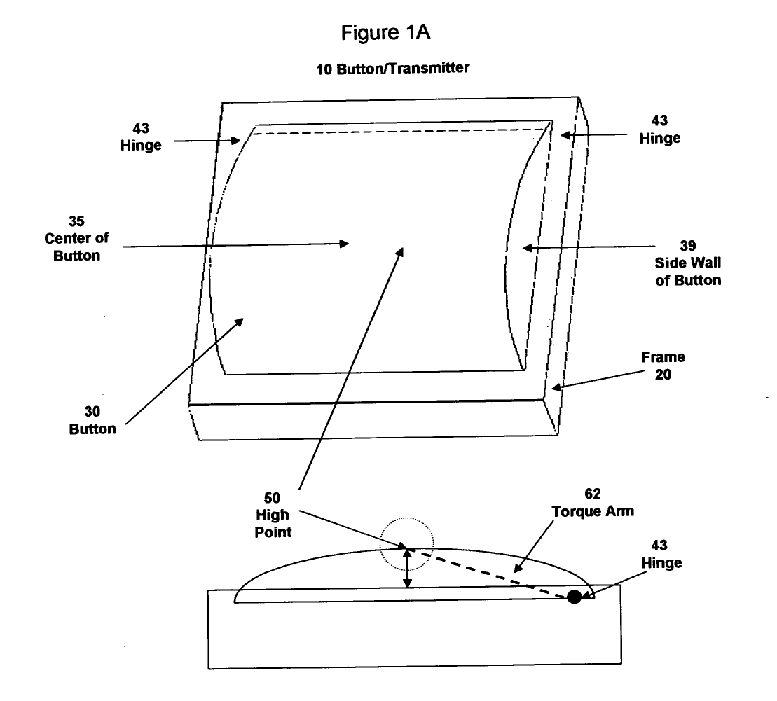

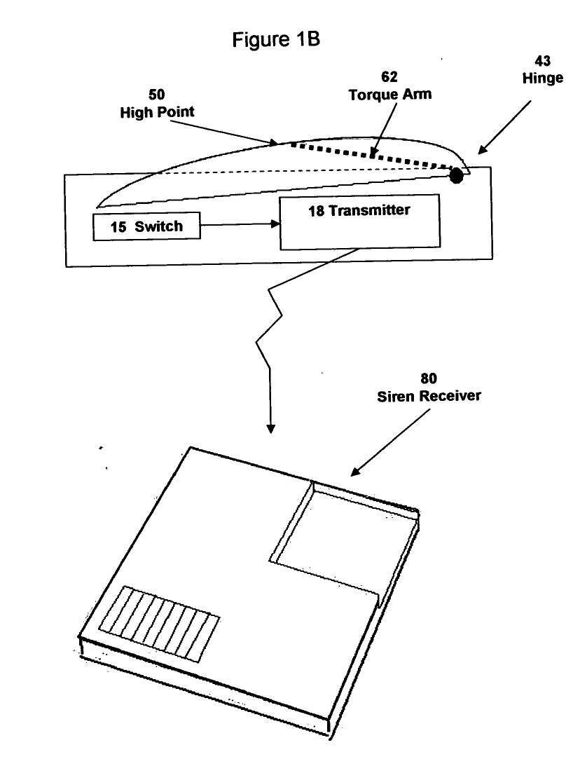

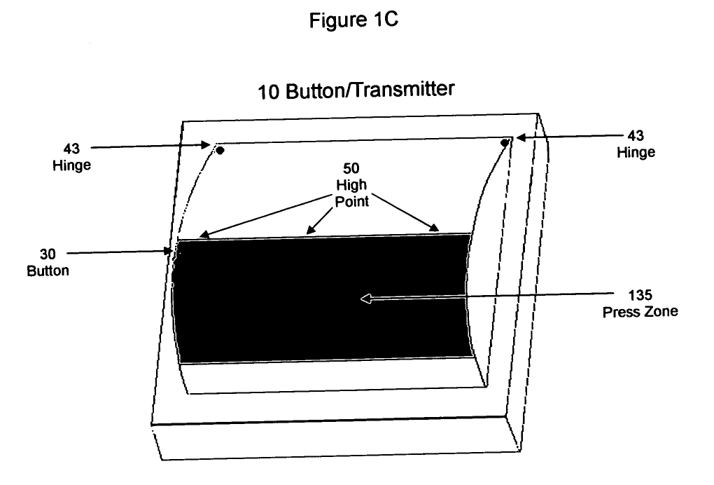

With reference to FIGS. 1A and 1B, when pushed, large button 30 on button/transmitter 10 closes a normally open contact switch and activates a digitally encoded radio frequency (RF) transmitter. The transmitter sends a signal to the receiver/siren unit 80 which receives and decodes the RF signal. If the receiver is in an inactive state the receiver toggles an audible alarm transducer into its active (audible) state. If the receiver is in an active state when it receives the RF signal the receiver toggles the unit into its inactive (silent) state. The digital encoding carried by the RF signal ensures the receiving unit will not false trigger when receiving other RF signals on the same frequency or near.

Both the receiver 80 and transmitter unit 10 are battery powered. Optionally one or both units may be AC line powered. Transmitter 10 consumes no power as it waits to be activated by the consumer, thus the transmitter's batteries will last substantially as long as the shelf life of the battery. Receiver 80 consumes small amounts of energy as it continuously listens for a transmitter signal to activate the alarm. When activated, the receiver will use larger amounts of energy as it simultaneously activates the alarm and listens for another signal from the transmitter. The batteries in the receiver need to be replaced regularly.

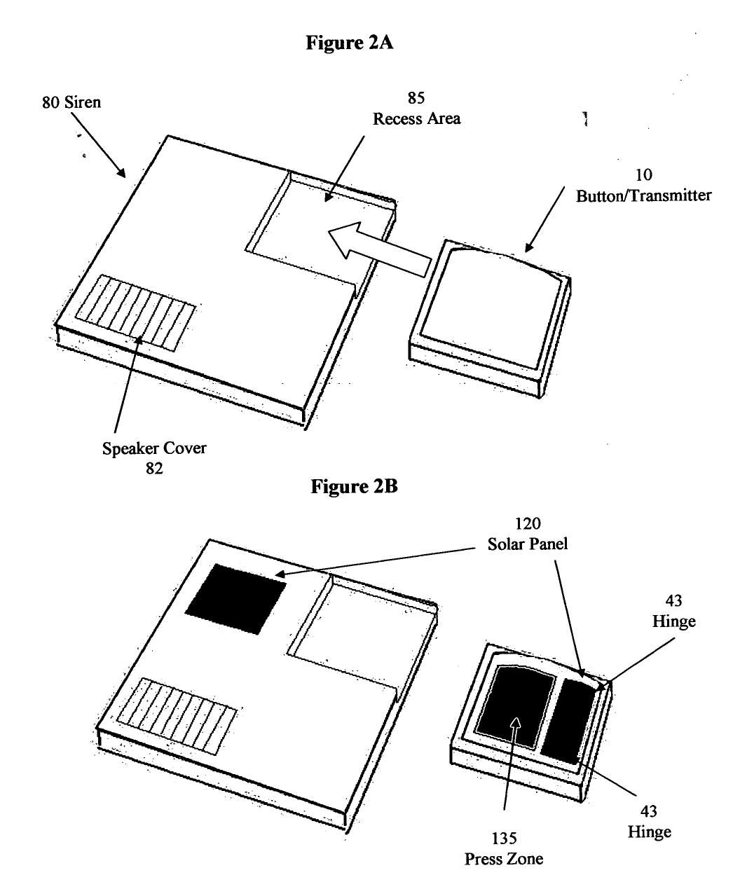

In an alternative embodiment, shown in FIG. 2B the batteries, or equivalent electrical energy storage device, within siren/receiver 80 and transmitter 10 unit may be connected to solar cells and be charged during daylight hours. If connected to solar cells there is normally no need for battery replacement. Solar panels 120 can be incorporated into transmitter 10 unit on button 30 (FIG. 1A) or into frame 20. Solar panel 120 (FIG. 2B) on the receiver/siren 80 could be incorporated anywhere in the housing cover.

As shown in FIG. 2B, the preferred location for solar panel 120 on button/transmitter 10 is proximate to hinge 43 and distinct from Press Zone 135. In this embodiment power from solar panel 120 may be transferred to rechargeable batteries within button/transmitter 10 through hinges 43. Hinges 43 incorporate conductive material. Solar panel 120 is connected to hinges 43 which are, in turn, connected to a rechargeable battery. To maintain cleanliness of solar panel 120 on button/transmitter 10, press zone 135 (FIG. 2B) may be textured provided to encourage pressing on high point 50 (FIGS. 1A and 1B).

As shown in FIG. 1A, button 30 substantially covers the top of button/transmitter 10, the perimeter of the button being greater than 50% and less than 95% of the perimeter of the complete assembled button/transmitter unit. Frame 20 surrounds the perimeter of button 30 to protect it from scraping against walls and other interferences. Button 30 is convex and the top of button 30 button bulges outward beyond a plane defined by the top of frame 20.

Convex button 30 is hinged such that the axis or alignment of hinge 43 is away from button center 35. In one embodiment, hinge 43 is comprised of recesses in opposing sides of frame 20 and corresponding pins on the sides of button 30. The hinge recesses may be located on the inner walls of frame 20 and not be visible on the outer walls. In an alternative embodiment the hinge is located along a single wall of frame 20 and a single edge of convex button 30.

Button 30 incorporates high point 50. High point 50 may be located in the center section of button 30 proximate to button center 35. Alternatively, high point 50 may be further away from hinge 43, off-center and away from button center 35. High point 50 may be located on any section of button 30 other than immediately adjacent to hinge 43. In preferred embodiments high point 50 is centered between hinge points 43 and between button center 35 and the edge of button 30 most distant from hinge points 43, anywhere within press zone 135 shown in FIGS. 1C and 2B (note that in FIG. 1C high point 50 is shown as a line corresponding to button center 35). While in the preferred embodiment high point 50 could be located anywhere within press zone 135, it is possible to locate high point 50 north of the latitude button center 35. High point 50 may comprise a peak. High point may 50 alternatively comprise a ridge on the apex of a rounded surface. High point 50 could also be a flat surface provided that the overall convex shape of button 30 is maintained.

In the preferred embodiment shown in FIG. 1A side walls 39 of button 30 incorporate sharply defined straight and parallel flat sides while upper and lower sections of button 30 slope smoothly downward from high point 50 to become flush with the top of frame 20 thereby creating a curved top section with flat sides. When incorporated with high point 50, the curved top of the button serves for intuitive operation in any orientation.

As shown in FIG. 1A hinge 43 is located away from high point 50 such that high point 50 does not align with hinge 43. Button 30 is cantilevered from hinge 43. The distance between high point 50 and hinge 43 defines torque arm 62. Torque arm 62 provides a mechanical advantage for actuation. In use, the point of highest pressure comprises the highest point of the curve and is remote from the hinge. This arrangement enables lower friction with a predictable actuation force in contrast to prior art designs that utilize a linear actuation motion. Hinge 43 extends across a width of button 30 so that the button is precisely guided by torque arm 62 within interior edges of frame 20 as the button rotates about hinge 43. Button 30 does not rely upon interior edges of frame 20 for guidance, and moving surfaces of button 30 will not slide against interior edges of frame 20. In contrast a linear translating button that does not include a substantial length hinge will by design press guide edges of a frame and therefore move with greater friction and less reliability. The oversized cantilevered hinged button with a defined high point enables easy operation by the user in a panicked state of mind.

Transmitter unit 10 can be mounted in a multitude of ways. In the preferred embodiment the bottom of the button/transmitter unit incorporates built in keyhole to hang from a screw or nail. The bottom may further incorporate a recess to assist in mounting by means of a hook and loop fastener system. Carpet tape or other mounting means may also be used. Button/transmitter unit 10 need not be mounted at all and can be placed horizontally on table. The bottom may also incorporate a non-slip material to help prevent slippage when located on a table top.

FIG. 2A shows siren unit 80 incorporating speaker cover 82 and recess area 85. Recess area 85 holds the base of button/transmitter 10 to facilitate shipping and storage of the two-unit system as a single element. Recess area 80 may incorporate a friction or snap fit to the base of button/transmitter 10 such that button/transmitter 10 is retained snugly and will not be dislodged accidentally. The combined unit may also serve as an integrated “panic button” unit appropriate for use in small rooms such as hospital and hotel rooms wherein the button/transmitter is optionally removable.

The enclosure of the receiver/siren unit 80 may be water resistant so that the unit can mounted either indoors or outdoors. The mounting methods described for the button/transmitter 10 may also be used for the receiver/siren 80. The battery power provides an automatic shut off feature when the battery runs down. The device may also emit a beep to signify that the batteries are low.

Transmitter unit 10 interfaces with any number of receiver units operating on a communicating frequency with enabling encoding. A single transmitter can be used to actuate multiple siren units.

In alternative embodiments siren unit 80 may incorporate one or more of the following additional features: flashing lights, automatic telephone calling, video camera, automatic email messaging.

As shown in FIG. 4, siren unit 80 could incorporate wireless interface 101 wherein the siren unit is incorporated in the local area network of a user's home. Video camera 202 could be integrated into siren unit 80 and directed from remote computer 96. In this embodiment with internet connectivity the following steps can take place when the siren is activated by button/transmitter 10:

1. A signal is sent from siren unit 80 to computer 90 on the local area network.

2. Computer 90 sends an email to one or more predetermined addresses informing the recipient(s) that the alarm has been activated.

3. Video camera 202 is activated. The video signal is sent to and stored on computer 90 on the local area network and may be accessed in real time or at a later time by remote computer 96.

In this embodiment the siren unit may be deactivated by a signal from the local computer (the local computer being operated from a remote location).

Siren unit 80 may also incorporate an amplifier/speaker system that is wirelessly connected to local computer 90 such that a user at a remote computer 96 is enabled to deliver audible messages through the siren unit speaker 81 into the home where transmitter 10 has been activated.

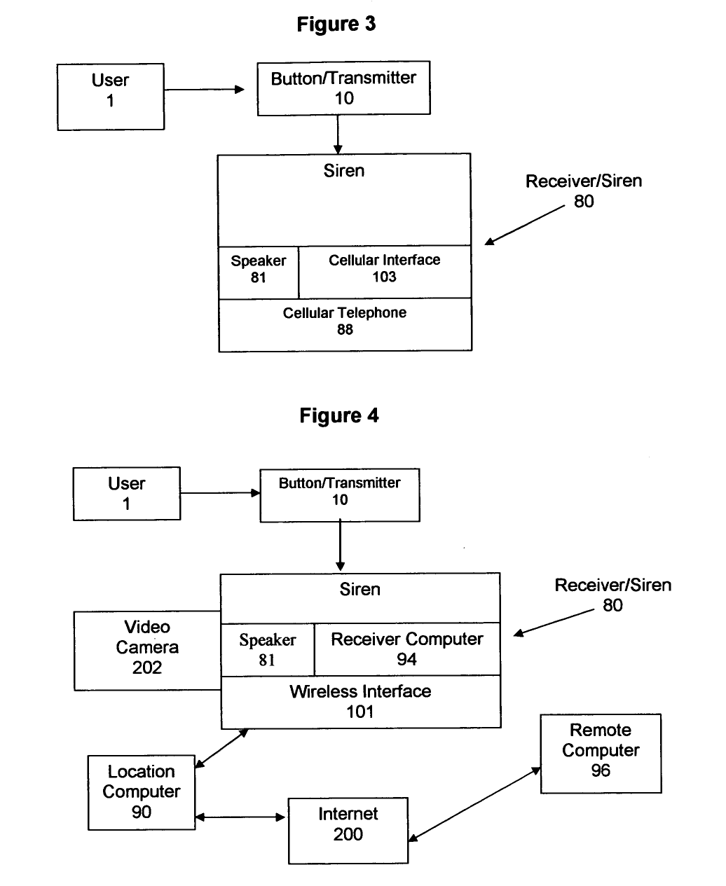

As shown in FIG. 3, siren unit 80 could also incorporate cellular interface 103 which may perform the function of a telephone answering/calling machine. Cellular interface 103 is integrated with wireless cellular telephone 88. Wireless cellular telephone 88 may be a integrated permanently in the unit. In the preferred embodiment cell-phone 88 is a stand-alone, removable cell phone, inserted into the unit by the user and integrated using existing interfaces built into cell-phone 88, for example a bluetooth two way transmitter. When siren unit 80 is activated by sender unit 10 cell-phone 88 calls a predetermined number and delivers a pre-recorded message. The device may be further enabled to receive phone calls and deliver amplified audible messages to anyone in the area of the siren unit. Incorporating a cell-phone into the system does not diminish portability the way a hard wired dedicated auto-dialing phone system would. This feature would enable someone with an infirm relative to monitor their activities and provide comfort by talking to them at the moment when panic is setting in.

The present invention thus embodies many methods to accomplish the function of alerting people in both local and remote areas while maintaining the benefit of complete portability. The system does not require any fixed interfaces.

We claim:

1. A battery-powered wireless alarm system comprising a transmitter unit and a receiver unit wherein;
the transmitter unit incorporates a convex rectangular actuator button surrounded by a frame wherein an outer perimeter of the actuator button is greater than 50% and less than 95% of an outer perimeter of the frame;
the actuator button incorporates a hinge wherein the actuator button is pivotally cantilevered from the hinge at a hinge axis;
the actuator button incorporates a high point that is offset from the hinge axis wherein the distance from the hinge axis to the high point comprises a torque arm;
and the torque arm guides the button within interior edges of the frame.

2. The wireless alarm system of claim 1 wherein the receiver unit incorporates a siren and speaker within a housing, a top of the receiver housing incorporating:
a speaker cover;
and a recess area for storing the transmitter unit.

3. The wireless alarm system of claim 1 wherein the high point of the actuator button comprises a peak.

4. The wireless alarm system of claim 1 wherein the high point comprises a ridge on the apex of a rounded surface.

5. The wireless alarm system of claim 1 wherein the high point comprises a flat surface wherein the convex shape of the button is maintained.

6. The wireless alarm system of claim 1 wherein the actuator button incorporates a curved top surface and flat sides.

7. The receiver unit of claim 2 incorporating an interface for a portable cellular telephone.

8. The receiver unit of claim 2 incorporating a telephone answering device whereby a remote caller may speak to a local user through the receiver.

9. A battery-powered wireless alarm system comprising a transmitter unit and a receiver unit wherein;
the transmitter unit incorporates an actuator button that is hinged to a surrounding frame wherein a top surface area of the actuator button is at least 50% of the combined top surface area of the actuator button and frame;
the actuator button comprises a convex shape with a high point near the a center of the button and incorporates a hinge that is spaced from the high point;
a distance between the hinge and the high point comprises a torque arm;
the transmitter unit is powered by a rechargeable battery;
a charge in the battery is maintained by a solar panel;
the solar panel is mounted on a top of the actuator button proximate to the hinge;
and power from the solar panel is sent to the rechargeable battery through a conductive material of the hinge.

10. The wireless alarm system of claim 2 wherein the receiver unit incorporates a rechargeable battery and the charge in the battery is maintained by a solar panel.

11. The wireless alarm system of claim 9 wherein the receiver unit incorporates a siren and speaker within a housing, the top of the receiver housing incorporating:
a speaker cover;
and a recess area for storing the transmitter unit.

12. The receiver unit of claim 11 further incorporating an interface for a portable cellular telephone.

13. The receiver unit of claim 9 incorporating a telephone answering device whereby a remote caller may speak to a local user through the receiver.

14. The receiver unit of claim 9 further incorporating wireless Internet connectivity.
